(19) United States
(12) Patent Application Publication
(10) Pub. No.: US 2012/0026637 A1
(43) Pub. Date: Feb. 2, 2012

(54) Fault Current Limiter

(76) Inventor: Francis Anthony Darmann, Chatswood (AU)

(21) Appl. No.: 13/019,752

(22) Filed: Feb. 2, 2011

(30) Foreign Application Priority Data
Mar. 12, 2010 (GB) 10 041 33.3

(51) Int. Cl. H02H 9/02

(52) U.S. Cl. 361/93.9

(57) ABSTRACT

A fault current limiter including: an input terminal for electrically connecting to a power source that provides a load current; an output terminal for electrically connecting with a load circuit that draws the load current; and at least a first and second core of high magnetic permeability material; at least a first and second interconnected AC coil with a first AC coil formed around a first core and the second AC coil formed around a second core; at least one DC coil for magnetically biasing the cores such that, in response to one or more characteristics of the load current, the AC coil moves from a low impedance state to a high impedance state. A high magnetic permeability non-laminated material formed between the first and second cores. The high magnetic permeability non-laminated material can comprise steel.

### FIELD OF THE INVENTION

The present invention relates to the field of fault current limiters and in particular discloses a compact fault current limiter (FCL) utilising an improved core design.

### BACKGROUND

Any discussion of the prior art throughout the specification should in no way be considered as an admission that such prior art is widely known or forms part of common general knowledge in the field.

In a modern society, it is growing increasingly important to ensure the stability of the electrical supply both on the small and large scale. One device of importance in the insuring of supply is the fault current limiter. Recently, magnetically saturated fault current limiters employing high permeability cores have been introduced to the market. Often these devices utilise a DC coil, superconducting or otherwise, for the magnetic saturation of a magnetic material. Upon the occurrence of a fault, the magnetically saturated material is often taken out of saturation so as to thereby provide a higher impedance to the fault current. Example fault current limiter devices relying upon magnetic saturation can be found in U.S. Pat. Nos. 7,551,410 and 7,193,825 of the present inventor.

In the design of a fault current limiter device, it is desirable to provide for as inexpensive a limiter as possible with in certain design criteria. There is also desire for compact form of a fault current limiter, with the design having improved operational characteristics.

### SUMMARY

It is an object of the present invention to provide an improved form of compact fault current limiter.

In accordance with a first aspect of the present invention, there is provided a fault current limiter including: an input terminal for electrically connecting to a power source that provides a load current; an output terminal for electrically connecting with a load circuit that draws the load current; and at least a first and second core of high magnetic permeability material; at least a first and second interconnected AC coil with a first AC coil formed around a first core and the second AC coil formed around a second core; at least one DC coil for magnetically biasing the cores such that, in response to one or more characteristics of the load current, the AC coil moves from a low impedance state to a high impedance state; a high magnetic permeability non-laminated material formed between the first and second cores.

In some embodiments, the high magnetic permeability non-laminated material can comprise steel. The first and second cores preferably have a substantially cylindrical outer surface. At least one of the DC coils can be a superconductor coil substantially surrounding a first or second coil. The superconductor coil can be surrounded and enveloped by a cryostat to facilitate cooling.

In some embodiments, the first and second cores extends longitudinally and the input and output terminals are preferably longitudinally spaced apart. The cores can extend substantially horizontally or vertically;

In accordance with a further aspect of the present invention, there is provided a fault current limiter including: a housing; an input terminal being coupled to the housing for electrically connecting to a power source that provides a load current; an output terminal being coupled to the housing and spaced from the input terminal for electrically connecting with a load circuit that draws the load current; and two sub-cores of high magnetic permeability which are received end-to-end within the housing; two AC sub-coils that are wound in opposite senses and coupled together at common ends and which can include free ends that are coupled to the input terminal and the output terminal respectively, wherein the sub-coils are wound about the respective sub-cores for carrying the load current between the terminals; at least one DC coil for magnetically biasing the sub-cores such that, in response to one or more characteristics of the load current, one or both of the AC sub-coils moves from a low impedance state to a high impedance state; and a buffer having a high permeability disposed between the sub-cores.

In some embodiments, the buffer is abutted with both the sub-cores. In some embodiments, the buffer is formed of a substantially uniform material and has a thickness greater than twice the skin depth for that material at the predetermined frequency.

### BRIEF DESCRIPTION OF THE DRAWINGS

Benefits and advantages of the present invention will become apparent to those skilled in the art to which this invention relates from the subsequent description of exemplary embodiments and the appended claims, taken in conjunction with the accompanying drawings, in which:

FIG. 1 illustrates a side perspective view of a single phase embodiment of the invention;

FIG. 2 illustrates a side plane view of a single phase embodiment of the invention;

FIG. 3 illustrates the electrically active portions of the single phase embodiment;

FIG. 4 illustrates an isometric view of a three phase example embodiment of the invention;

FIG. 5 illustrates the measured 50 Hz impedance of an FCL with a non-laminated steel insert and the measured FCL impedance with an air gap;

FIG. 6 is a graph illustrating the measured 50 Hz impedance of an FCL with a non-laminated steel insert at low and high AC current (left hand scale) and the ratio of these two curves (right hand scale);

FIG. 7 illustrates and contrasts the measured 50 Hz AC impedance of two cases, namely, the FCL with the presence of the non-laminated steel insert and that with an air gap between the two sub cores;

FIG. 8 is a graph illustrating the transient fault current of the FCL at 50 Hz in response to a dead short circuit across the circuit load terminals;

FIG. 9 is a graph illustrating the change in the flux density in the steel core in response to the transient behaviour during the short circuit event and when a non-laminated steel insert is employed; and

FIG. 10 is a graph illustrating the voltage across the FCL terminals during the fault event and with a non-laminated steel core insert employed;

### DETAILED DESCRIPTION

Preferred embodiments of the invention will now be described, by way of example only, with reference to the accompanying drawings.

In the prior art fault current limiter devices utilising a saturated magnetic core, it has been the usual practice to utilise an air gap between the laminated cores of each saturated sub core.

It will be appreciated by those skilled in the art that the word “Laminated” is employed throughout this text to convey the meaning that a core is laminated with transformer like laminations, usually 0.1 mm to 0.5 mm thick but not restricted to this range. That is, thin sheets of high permeability silicon steel material coated with a thin layer of electrical insulation. Such a laminated core substantially prevents the flow of circulating screening eddy currents, although not completely, and as such allows a sub core to be saturated by a DC current flowing in a coil which envelopes the core and may additionally be de-saturated completely by an AC current flowing in a coil which envelopes the core. It should also be appreciated that the customary direction of lamination is along the longitudinally extended major axis of the sub cores.

In a similar manner, the expression “non-laminated core” or “non laminated steel core” refers to a high permeability core structure which is not made from transformer like laminations but rather is made from a single bulk monolith. Such bulk monoliths of high permeability material allow, circulating screening eddy currents to flow within their complete structure, cross section, and depth. As a result, except for the skin depth of these monoliths, any DC flux density within the bulk of the monolith cannot be de-saturated by a coil carrying a power frequency current because that effect is prevented by induced screening currents.

In the construction of compact open core fault current limiters, it is also the usual practice to provide for two sub cores, with one of the cores dedicated to each half cycle of the alternating current cycle. Hence, a first of the sub cores is taken out of saturation if a fault occurs on the first half of an AC cycle and the second sub core is taken out of saturation in the second half of the AC cycle thereby limiting the fault current transient waveform over the entire temporal range. Normally, an air gap is provided between the two sub cores so as to magnetically decouple as far as possible the two sub cores, as without the air gap, the two laminated sub cores can interfere with one another, providing a reduced performance and a substantial operational penalty.

It has been surprisingly found that the utilisation of the air gap can lead to a sub optimal design. It has been found that a solid steel core monolith (i.e. a non-laminated steel core insert) between the two sub cores provides for improved functional results over that normally experience with the utilisation of an air gap. The essential reason, as will be described herewith, is that by filling the air gap with non laminated steel, the optimum DC biasing of the FCL may be achieved with far less DC ampere-turns and the fault current limiting performance is improved. If laminated steel was employed then effectively there would be one long steel core and the two sub components would not be electromagnetically de-coupled.

Without wishing to be bound by theory, it is considered that the skin depth of a solid steel insert, at say a 50 to 60 Hz fault operating frequency, is less than 1 millimetre. Hence, a non-laminated bulk steel material can be employed in the gap between the cores instead of air, with the skin effect acting to only demagnetise the skin of the solid steel insert during each phase.

The resultant single long hybrid core can then be magnetised by a DC current coil in a similar manner to the described prior art. The non-laminated solid steel core insert piece cannot be de-magnetised by the 50/60 Hz power frequencies due to the small skin depth. This phenomenon can be employed to build a more efficient single phase and three phase fault current limiting core structure which biases with fewer DC ampere-turns and yet has a fault current clipping performance which is greater as a design where the cores are de-coupled by an air gap.

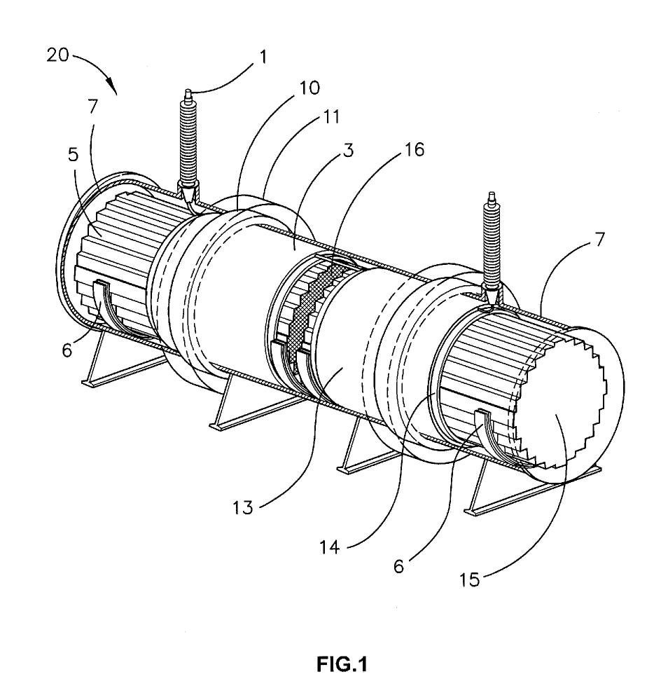

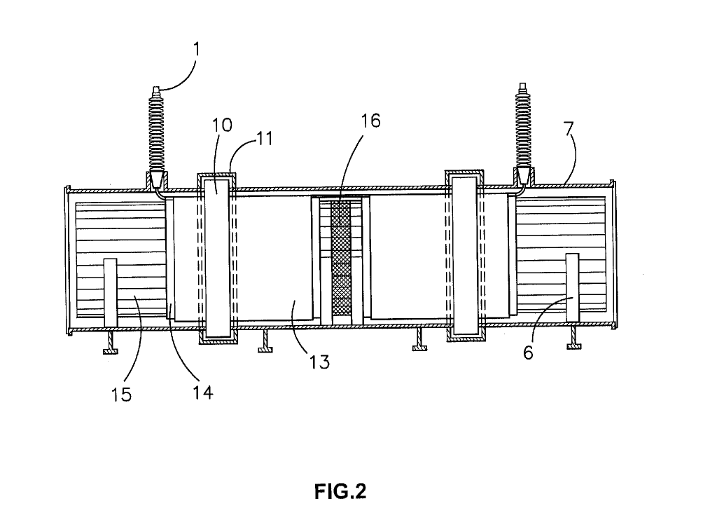

FIG. 1 illustrates an example single phase fault current limiter device 20 constructed with the non laminated steel insert. The single phase fault current limiter provides a high-voltage input and output terminal 1, 2. The input 1 is connected to a first AC phase coil 3 which is formed around a highly permeable or laminated material 5. The core 5 is insulated 6 from an external tank 7. In other embodiments, the core and the tank and both connected to a common earth. Around the AC phase coil 3 there is formed a DC superconducting coil which is cooled by a cryocooler or a cryogenic liquid in a cryostat 11. The AC phase coil 3 is in turn connected to a second AC phase coil 13 which is wrapped around a former 14 around the second core 15. Between the two cores there is placed a non-laminated high permeability material such as that formed from steel 16. The non-laminated high permeability material replaces the usual air gap between the two cores. FIG. 2 illustrates a side plan view of the first embodiment.

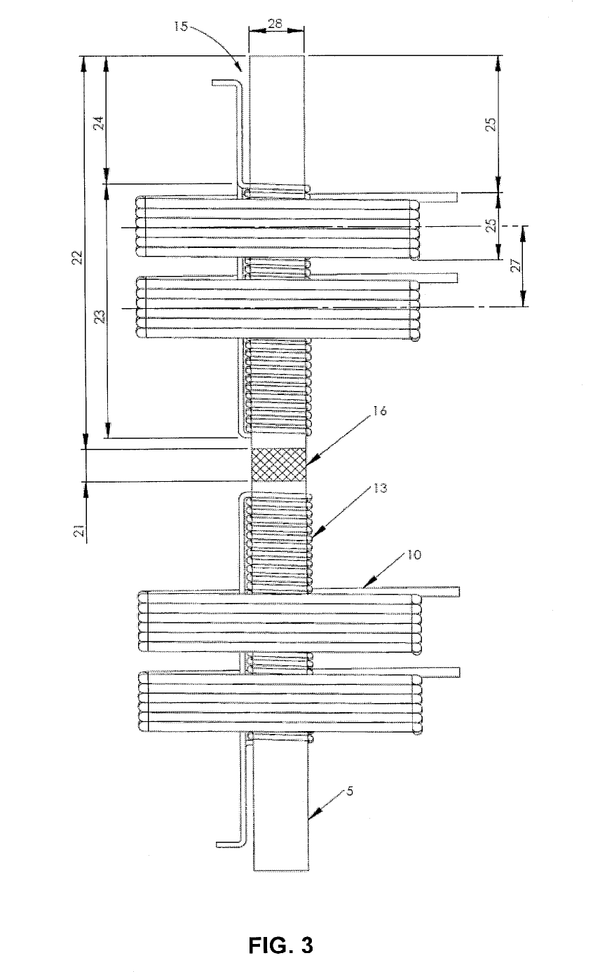

Simulations using FEA techniques and direct measurements on prototypes of the operation of the arrangement 20 of FIG. 3 both with and without the non laminated steel insert were carried out and various results are now discussed. The core arrangement of FIG. 3 is colloquially referred to as a “1×2” structure signifying that there is one longitudinally extended core along one axis and two sub cores displaced along the same longitudinal axis. A three phase FCL equivalent of FIG. 3 would then be referred to as a “3×2” structure in this colloquial naming convention.

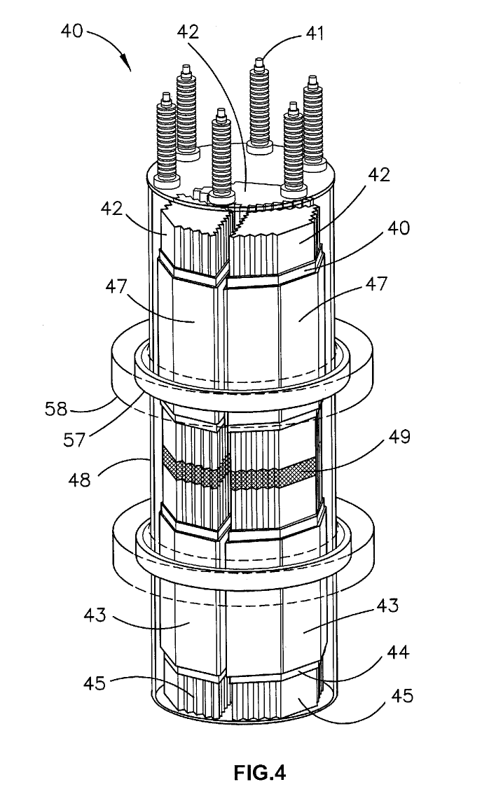

FIG. 4 shows the layout 40 of core components of a prototype three phase device of the “3×2” structure in an arrangement which allows for an efficient compact steel core and AC coil structure and in addition a round DC bias coil. There are often can be advantages in the ease of construction of the DC superconducting coil if it is geometrically round. The structure 40 includes two sets of three sub cores 42, 45 around which corresponding AC coils are wound 47, 43. Between each sub core of each phase is a solid steel insert e.g. 49. Two cryostats e.g. 58 are provided for saturating the cores in addition to DC coils 57. The AC coils are connected (not shown to input/output terminals 41. The system is contained within vessel 48.

FIG. 3 illustrates the FCL that was built and tested in order to confirm the theory and operation of the FCL with and without the non-laminated steel core insert, and the parameters utilised in the fault current limiter operation. FIG. 3 also illustrates the DC coils employed to bias the FCL, the AC phase coils and the laminated cores in addition to the non-laminated high permeability material between the two cores. FIG. 3 also illustrates the various measurement of variables utilised in the simulation. Table 1 details the physical parameters of the FCL. Ordinary mild steel commonly employed for construction work was employed as the non-laminated high permeability material between the two sub-cores, any other non-laminated high permeability material may have been employed.

TABLE 1

| | Abbrevi- | | Indication |
|---|---|---|---|
| Dimension or value | ation | Value and unit | in FIG. 3 |
| Laminated steel core cross | A_{core} | 80 mm × 80 mm | 28 |
| sectional area | | | |
| Length of each sub core | H_{core} | 600 mm | 22 |
| Length of each AC coil | H_{AC} | 400 mm | 23 |
| Number of turns in each | N_{AC} | 60 | 13 |
| AC coil | | | |
| Number of DC coil turns in | N_{DC} | 400 | 10 |
| total | | | |
| Height of each DC coil | H_{DC} | 100 mm | 25 |
| Non laminated steel core | A_{core2} | 80 mm × 80 mm | 16 |
| cross sectional area | | | |
| Inner cross section of the | A_{AC}_{_{—}}_{coil} | 86 mm × 86 mm | |
| DC coils | | | |
| Height of the non laminated | H_{core2} | 50 mm | 21 |
| steel core insert | | | |
| Sub core material | | 0.30 mm thick M4 | |
| | | silicon steel | |
| | | transformer | |
| | | laminations | |
| Insert core material | | Steel (non | |
| | | laminated) | |

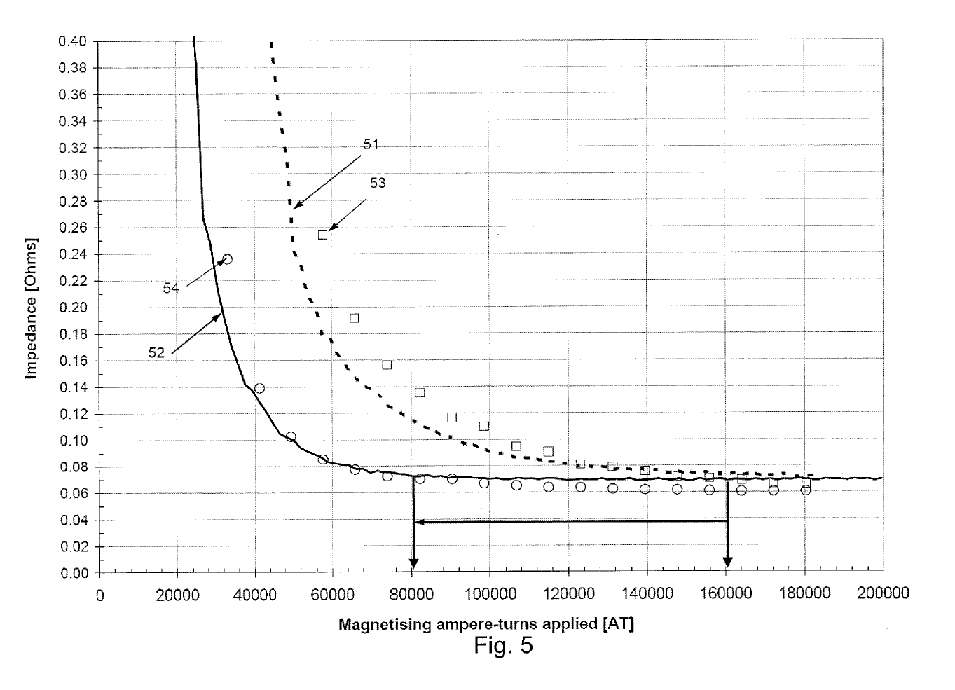

Turning to FIG. 5, there is illustrated a graph of measured and FEA simulation results between the 50 Hz FCL AC impedance obtained with and without a non-laminated steel insert as a function of the applied DC biasing ampere-turns. The plot 51 represents the measured impedance of the FCL with an air gap between the two sub cores and the plot 52 represents the measured impedance of the FCL with a non laminated steel core insert employed between the two sub cores. It can be seen that there is a substantial improvement requiring less applied DC ampere turns in the case where a non laminated steel insert is utilised. The plots 53 and 54 show the expected results for each measured curve obtained using a Finite element analysis technique.

As can be appreciated, the minimum steady state impedance reached for both arrangements, 0.07 Ohms, is identical and is equivalent to the impedance which would otherwise result if the AC coil were employed on its own in the circuit without any other materials present. That is, it is equivalent to the air core impedance of the AC coils employed.

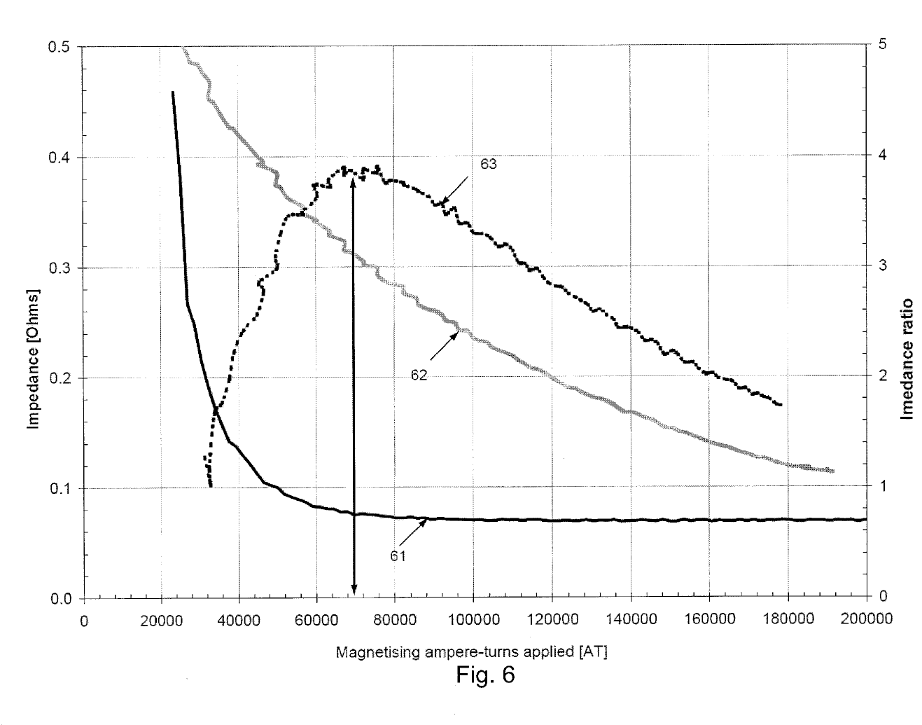

FIG. 6 illustrates the measured 50 Hz AC impedance as a function of the applied DC ampere-turns with a non-laminated steel core insert and for the case 61 where a 50 Amp rms AC current flows through the AC coils and the plot 62 where a 1000 A AC rms current flows through the AC coils. The plot 61 illustrates the un-faulted steady state impedance characteristics of the FCL. The plot 62 illustrates the fault impedance of the device as a function of the applied DC ampere-turns. The increase in the FCL AC impedance between the low AC current case 61 the high AC current 62 case is evident, illustrating the nature of the saturated core fault current limiter, and the effective operational behaviour of the device for limiting fault currents. The plot 63 illustrates the ratio of the low current and high current impedance curves illustrating that there is an optimum DC bias operation point at which this impedance ratio is maximised. Operational effectiveness of the FCL is determined by the magnitude of this impedance ratio. Ideally, an FCL will have a minimum impedance in the un-faulted state and a maximum impedance during the faulted state.

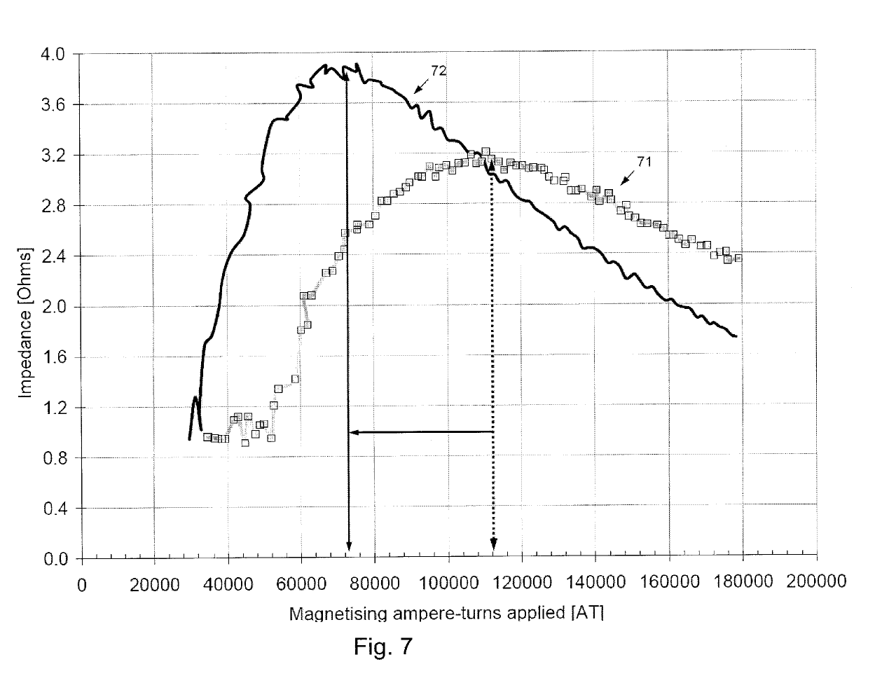

FIG. 7 illustrates the measured impedance ratio between the low AC current case (50 Amps AC rms) and the high AC current case (1000 Amps AC rms) as a function of the applied DC ampere-turns for the two cases of an air gap between the two sub cores 71 and a non laminated steel core insert between the two sub cores 72. The plots in FIG. 7 illustrate that the optimum DC bias point for operation of this FCL is shifted to lower applied DC biasing ampere-turns by the presence of the non laminated steel core insert. In addition, the maximum impedance ratio at the new optimum bias point is increased by the presence of the non laminated steel core insert and occurs at a DC bias value which provides minimum FCL impedance. In contrast, the optimum DC bias for the arrangement without the non laminated steel core insert 71 does not simultaneously provide for a minimum AC impedance of the device. Hence, the air gap FCL device cannot be optimally biased for simultaneous FCL fault limiting functionality and low steady state un faulted impedance and a compromise must be made. The device with the non laminated steel core insert, however, can be optimally biased to achieve both of these requirements.

FIGS. 5,6, and 7 essentially characterise the steady state fault current impedance response of the saturated core FCL device with and without the non-laminated steel core insert. The proof of a functional FCL device is in it's ability to demonstrate the limitation of a fault current to a value substantially below that which would flow in the circuit without the presence of the FCL.

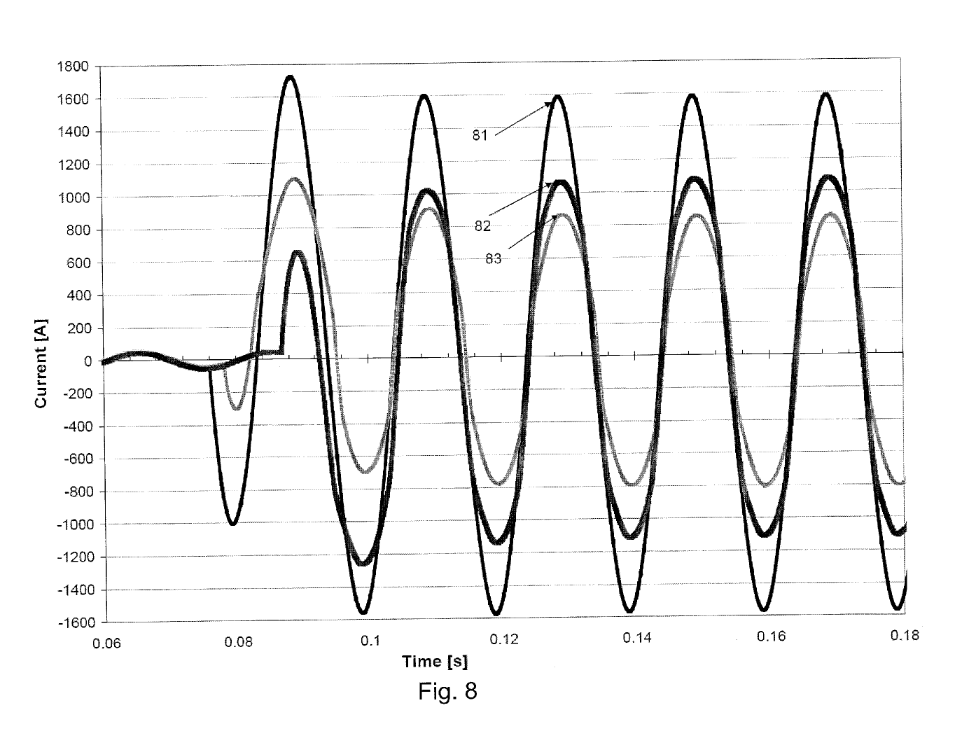

FIG. 8 illustrates the measured AC line current transient when the AC circuit load is short circuited. The plot 81 shows the fault current in the AC circuit when the two laminated steel sub cores and the non-laminated steel core insert are removed leaving only the test circuit and the AC coils of the FCL. By characterising the fault current of the complete circuit and the AC coils in this manner one can gain a better appreciation of the benefit of the steel cores and the non laminated steel core inserts.

The plot 82 shows the fault current response of the device when the laminated steel sub cores are inserted inside the AC coils according to FIG. 3 and the FCL is biased such that the AC impedance is minimised and therefore equivalent to the air core impedance as described previously. An air gap remains between the two sub cores, that is, the non laminated steel core insert is not inserted. The DC bias applied was 160 kAT. The fault current reduction achieved by this FCL was measured at 32%, representing the reduction in the peak steady state fault current from 1600 Amps to 1088 Amps.

Plot 83 shows the fault current response of the device when the laminated steel sub cores are inserted and the non laminated steel core insert is also inserted according to FIG. 3 and the FCL biased for optimum impedance ratio in this new arrangement as described previously. The DC bias applied was 75 kAT. The fault current reduction achieved by this FCL with the non laminated steel core insert is 47%, representing the reduction in the peak fault current from 1600 Amps to 848 Amps. This is a substantial improvement over the FCL without the non laminated steel core insert. Hence, not only is the DC bias required significantly reduced but the amount of fault current reduction, that is the operational effectiveness of the device, is also enhanced.

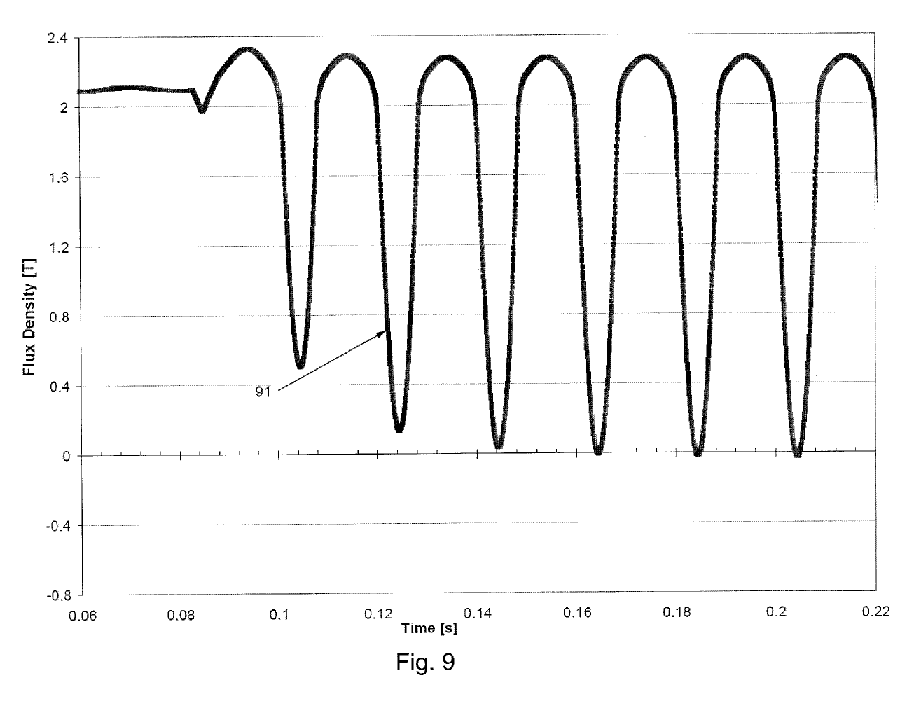

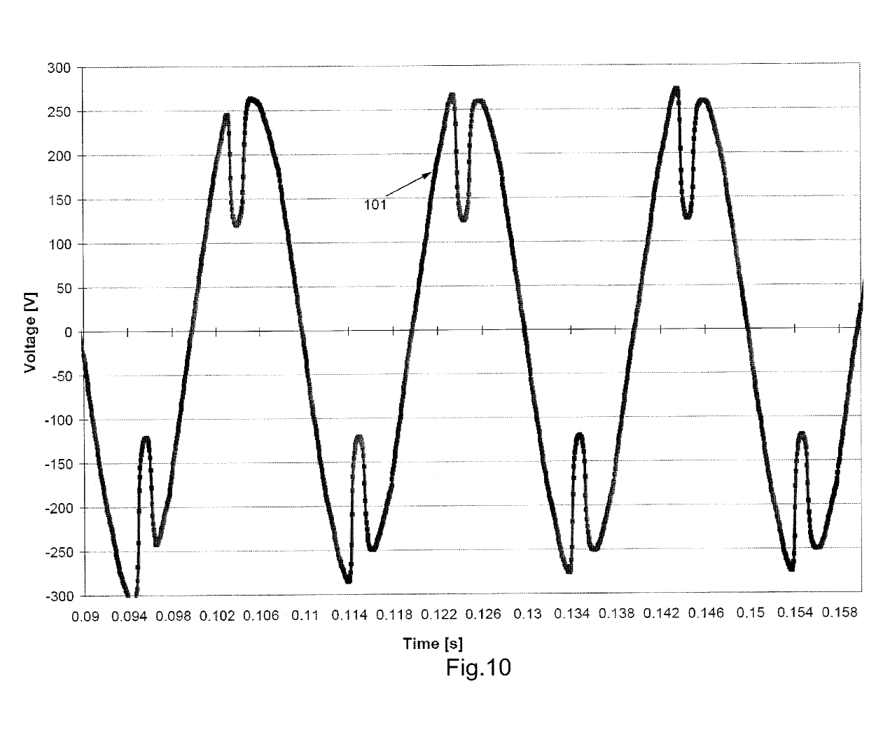

To further convey the mechanism by which the saturated core FCL functions, reference is now made to FIG. 9 and FIG. 10 which illustrate further measurements made on a prototype design similar to that depicted in FIG. 3 when the non laminated steel core insert is present. FIG. 9 shows the measured variation in the flux density in the geometrical centre of one of the laminated sub cores during the fault current transient 91. FIG. 10 shows the measured voltage transient across the terminals of the FCL during the fault current transient event 101.

Hence, in summary by employing a non laminated steel core insert in the FCL structure of FIG. 3, three distinct advantages have been found through direct measurement and simulations:

1. Lower DC bias ampere-turns are required to reach the minimum AC impedance of the FCL device for steady state operation. This advantage can save significant costs of the superconductor;

2. The optimum DC bias point, i.e., that which results in maximum impedance during the fault, now substantially coincides with that which also simultaneously provides for a minimum AC steady state impedance of the device in the un-faulted state. This was not the case when an air gap was utilised between the two sub cores and hence optimal operation, i.e. minimum un-faulted steady state impedance and maximum fault impedance, was not possible for the device employing the air gap;

3. The operational effectiveness, or, the magnitude of the fault current limiting ability at the optimum DC bias point, is enhanced.

It has been found generally through measurement and simulation that the utilisation of a non-laminated steel core insert provides substantial advantages over an air gap system. Of course, other non-laminated materials having a high permeability can be utilised in the place of the steel insert with different materials leading to different levels of improvement.

The analysis of the DC bias of standard symmetrical 1×2 core compared to that for an asymmetrical core with a solid steel non-laminated centre piece de-coupling the two half phases shows the potential improvement in utilising the non-laminated core centre piece.

It will be appreciated that the advantage of a lower DC bias shown in the above analysis and description obtained by including a non-laminated steel core insert may be substituted for shorter laminated steel sub-cores with the height of the AC coils remaining fixed and the DC bias required remaining fixed. From the analysis, it estimated that 30% of the steel laminated core mass can be saved (For example, the core length is reduced from 3.0 m long to 2.0 m long) and 20% of the DC Bias ampere-turns (and hence HTS tape length) can be saved compared to the base case of two sub cores with an air gap between them or two isolated sub-cores separated by a large distance.

In general, the designer may alternatively choose a combination or a compromise of shorter laminated steel sub cores and lower DC bias each of which is not the minimum achievable but are chosen according to engineering and economic considerations.

It will be evident that the non-laminated core insert can be made from any magnetic material. It can be steel, ferromagnetic, grain oriented or non-oriented. Commonly available materials like Hiperco (Trade Mark) are also suitable.

Further, the sub cores can also be formed from other materials than steel transformer laminations and can be made from any laminated high permeability material. In the conducted experiments, ordinary M4 transformer steel was utilised for the sub cores as it was readily sourced. A material like Hiperco (Trade Mark) is also highly suitable. It has a high saturation value of circa 2.4 Tesla which is higher than that of steel transformer laminations and can enhance the operational effectiveness of the compact FCL described in the art described here.

### Interpretation

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

Similarly, it is to be noticed that the term coupled, when used in the claims, should not be interpreted as being limitative to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Although the present invention has been described with particular reference to certain preferred embodiments thereof, variations and modifications of the present invention can be effected within the spirit and scope of the following claims.

1.-14. (canceled)

15. A fault current limiter, comprising:
an input terminal electrically connecting to a power source that provides a load current;
an output terminal electrically connecting with a load circuit that draws the load current;
at least first and second cores of high magnetic permeability material;
at least first and second interconnected AC coils with a first AC coil formed around the first core and the second AC coil formed around the second core;
at least one DC coil magnetically biasing the cores such that, in response to at least one characteristic of the load current, the AC coil moves from a low impedance state to a high impedance state; and
a high magnetic permeability non-laminated material formed between the first and second cores.

16. The limiter of claim 15, wherein the high magnetic permeability non-laminated material comprises steel.

17. The limiter of claim 15, wherein the high magnetic permeability non-laminated material comprises Hiperco.

18. The limiter of claim 15, wherein the first and second cores have a substantially cylindrical outer surface.

19. The limiter of claim 15, wherein the at least one DC coil is a superconductor coil substantially surrounding one of the first coil and the second coil.

20. The limiter of claim 19, wherein the superconductor coil is surrounded by a cryostat and cooled with a cold head connected to a cryocooler or immersed in a cryogenic liquid.

21. The limiter of claim 15, wherein the first and second cores extends longitudinally and the input and output terminals are longitudinally spaced apart.

22. The limiter of claim 15, wherein the cores extend substantially horizontally.

23. The limiter of claim 15, wherein in use, the AC coil extends longitudinally beyond the at least one DC coil.

24. The limiter of claim 15, wherein in use, the core extends longitudinally beyond the at least one DC coil.

25. The limiter of claim 15, wherein in use, at least one of the cores extends longitudinally beyond the AC coil.

26. A fault current limiter, comprising:
a housing;
an input terminal coupled to the housing for electrically connecting to a power source that provides a load current;
an output terminal coupled to the housing and spaced from the input terminal for electrically connecting with a load circuit that draws the load current;
two sub-cores of high magnetic permeability which are received end-to-end within the housing;
two AC sub-coils that are coupled together at common ends and which include free ends that are coupled to the input terminal and the output terminal respectively, wherein the sub-coils are wound about the respective sub-cores for carrying the load current between the terminals;
at least one DC coil magnetically biasing the sub-cores such that, in response to at least one characteristic of the load current, at least one of the AC sub-coils moves from a low impedance state to a high impedance state; and
a buffer having a high permeability disposed between the sub-cores.

27. The limiter of claim 26, wherein the buffer is abutted with both the sub-cores.

28. The limiter of claim 26, wherein the buffer is formed of a substantially uniform material and has a thickness greater than twice the skin depth for that material at the predetermined frequency.
